(19) United States
(12) Patent Application Publication
(10) Pub. No.: US 2015/0305091 A1
(43) Pub. Date: Oct. 22, 2015

(54) IRON-NICKEL-CHROMIUM-SILICON-ALLOY

(71) Applicant: VDM Metals GmbH, Werdohl (DE)

(72) Inventors: Heike HATTENDORF, Werdohl (DE); Juergen WEBELSIEP, Witten (DE)

(21) Appl. No.: 14/255,398

(22) Filed: Apr. 17, 2014

(51) Int. Cl. H05B 3/12; C22C 38/54; C22C 38/52; C22C 38/50; F27D 99/00; C22C 38/06; C22C 38/04; C22C 38/02; C22C 38/00; C22C 30/00; C22C 38/34

(52) U.S. Cl. CPC H05B 3/12; C22C 30/00; C22C 38/54; C22C 38/52; C22C 38/50; C22C 38/34; C22C 38/06; C22C 38/04; C22C 38/02; C22C 38/005; C22C 38/001; F27D 99/0006; F27D 2099/0008

(57) ABSTRACT

Iron-nickel-chromium-silicon alloy having (in % by weight) 34 to 42% nickel, 18 to 26% chromium, 1.0 to 2.5% silicon, and additives of 0.05 to 1% Al, 0.01 to 1% Mn, 0.01 to 0.26% lanthanum, 0.0005 to 0.05% magnesium, 0.01 to 0.14% carbon, 0.01 to 0.14% nitrogen, max. 0.01% sulfur, max. 0.005% B, remainder iron and the usual impurities resulting from the production process.

### CROSS REFERENCE TO RELATED APPLICATIONS

The present application is a continuation of pending U.S. application Ser. No. 12/086,822 filed Jul. 14, 2009, which is a continuation of International Application No. PCT/DE2008/000060 filed Jan. 15, 2008. The disclosures of these applications are incorporated herein by reference.

### BACKGROUND OF THE INVENTION

The invention relates to an iron-nickel-chromium-silicon alloy having improved service life and dimensional stability.

Austenitic iron-nickel-chromium-silicon alloys having different nickel, chromium, and silicon contents have been used for some time as heat conductors in temperatures ranging up to 1100° C. This alloy group is standardized in DIN 17470 (Table 1) and ASTM B344-83 (Table 2). Table 3 lists a number of commercially available alloys for this standard.

The sharp increase in the price of nickel in recent years has given rise to the desire to use heat conductor alloys that have the lowest possible nickel content. In particular there is a desire to replace the high nickel-content variants NiCr8020, NiCr7030, and NiCr6015 (Table 1), which are distinguished by particularly advantageous properties, with materials having a reduced nickel content without having to make major sacrifices in the performance of the material.

In general it should be noted that the service life and the usage temperature of the alloys listed in Tables 1 and 2 increase as nickel content increases. All of these alloys form a chromium oxide layer (Cr₂O₃) with a more or less closed SiO₂ layer disposed thereunder. Small additions of elements with high affinity for oxygen, such as Ce, Zr, Th, Ca, Ta (Pfeifer/Thomas, Zunderfeste Legierungen [Non-scaling Alloys], 2nd edition, Springer Verlag 1963, pages 258 and 259) increase the service life, in the aforesaid case only the effect of a single element with affinity for oxygen having been investigated, but no information having been provided on the effect of combining such elements. As a heat conductor is used, the chromium content is slowly consumed for building the protective layer. Therefore the service life is increased by a higher chromium content because a higher content of the element chromium, which forms the protective layer, delays the point in time at which the Cr content is below the critical limit and oxides other than Cr₂O₃ form, which are e.g. iron-containing oxides.

Known from EP-A 0 531 775 is a heat-resistant thermally moldable austenitic nickel alloy having the following composition (in % by weight):

| | |
|---|---|
| C | 0.05-0.15% |
| Si | 2.5-3.0% |
| Mn | 0.2-0.5% |
| P | no more than 0.015% |
| S | no more than 0.005% |
| Cr | 25-30% |
| Fe | 20-27% |
| Al | 0.05-0.15% |
| Cr | 0.001-0.005% |
| SE | 0.05-0.15% |
| N | 0.05-0.20% |

remainder Ni and impurities related to the melting process.

EP-A 0 386 730 describes a nickel-chromium-iron alloy that has very good oxidation resistance and heat resistance as is desired for advanced heat conductor applications and that proceeds from the known heat conductor alloy NiCr6015 and in which it was possible to attain significant improvements in usage properties by adjusting to one another modifications made to the composition. The alloy is distinguished from the known NiCr6015 material in particular in that the rare earth metals are replaced with yttrium, in that they also contain zirconium and titanium, and in that the nitrogen content is adjusted in a special manner to the zirconium and titanium content.

From WO-A 2005/031018 can be taken an austenitic Fe—Cr—Ni alloy for use in the high temperature range that has largely the following chemical composition (in % by weight):

| | |
|---|---|
| Ni | 38-48% |
| Cr | 18-24% |
| Si | 1.0-1.9% |
| C | <0.1% |
| Fe | remainder |

For free-hanging heating elements, in addition to the requirement for a long service life there is also the requirement for good dimensional stability at the application temperature. A coil that sags too much during operation (sagging) results in uneven spacing of the windings and uneven temperature distribution, shortening service life. In order to counteract this, more support points would be necessary for the heating coil, which increases the costs. This means that the heat conductor material must have sufficiently good dimensional stability and creep resistance.

The creep mechanisms that have a negative impact on dimensional stability in the application temperature range (dislocation creep, grain boundary migration, and diffusion creep) are all influenced toward greater creep resistance by a large grain size (except for dislocation creep). Dislocation creep is not a function of grain size. Producing a wire with a large grain size increases creep resistance and therefore dimensional stability. Grain size should therefore also be considered as an important factor.

Also significant for a heat conductor material is the highest possible specific electrical resistance and the lowest possible change in the heat resistance/cold resistance ratio with the temperature (temperature coefficient ct).

In particular the variants with lower nickel content, NiCr3020 and 35Ni, 20Cr (Table 1 and Table 2), which are distinguished by significantly lower costs, do not satisfactorily fulfill the service life requirements.

### SUMMARY OF THE INVENTION

The object is thus to design an alloy that, with significantly lower nickel content than NiCr6015 and thus with significantly lower costs, has
a) high oxidation resistance and thus concomitant long service life;
b) sufficiently good dimensional stability at the application temperature;
c) high specific electrical resistance in conjunction with the least possible change in the heat resistance/cold resistance ratio with the temperature (temperature coefficient ct).

This object is attained using an iron-nickel-chromium-silicon alloy having (in % by weight) 34 to 42% nickel, 18 to 26% chromium, 1.0 to 2.5% silicon, and additives of 0.05 to 1% Al, 0.01 to 1% Mn, 0.01 to 0.26% lanthanum, 0.0005 to 0.05% magnesium, 0.01 to 0.14% carbon, 0.01 to 0.14% nitrogen, no more than 0.01% sulfur, no more than 0.005% B, remainder iron and the usual impurities resulting from the production process.

Due to its special composition, this alloy has a longer service life than the alloys according to the prior art that have the same nickel and chromium content. In addition, with 0.04 to 0.10% carbon it is possible to attain increased dimensional stability and less sagging than with the alloys according to the prior art.

The range for the element nickel is between 34 and 42%, wherein, depending on employment, the nickel content can be as follows:
34-39%
34-38%
34-37%
37-38%.

The chromium content is between 18 and 26%, wherein depending on the area of employment, here as well, the chromium content can be as follows:
20-24%
21-24%

The silicon content is between 1.0 and 2.5%, wherein, depending on the area of application, the defined content can be adjusted within the range:
1.5-2.5%
1.0-1.5%
1.5-2.0%
1.7-2.5%
1.2-1.7%
1.7-2.2%
2.0-2.5%

The element aluminum is provided as an additive, specifically aluminum content is 0.05 to 1%. It can preferably also be adjusted as follows in the alloy:
0.1-0.7%

The same applies for the element manganese, which is added at 0.01 to 1% of the alloy. The following range is also alternatively conceivable:
0.1-0.7%
The inventive subject-matter preferably proceeds from the fact that the material properties provided in the examples are largely adjusted by adding the element lanthanum for a lanthanum content of 0.01 to 0.26%. Depending on the area of application, defined values can be adjusted in the alloy here as well:
0.01-0.2%
0.02-0.15%
0.04-0.15%

This also applies analogously for the element nitrogen, which is added to attain nitrogen content between 0.01 and 0.14%. Defined content can be provided as follows:
0.02-0.10%
0.03-0.09%

Carbon is added to the alloy analogously, specifically to attain carbon content between 0.01 and 0.14%. Content can be adjusted specifically as follows in the alloy:
0.04-0.14%
0.04-0.10%

Magnesium is also among the elements that can be added to attain magnesium content of 0.0005 to 0.05%. Specifically it is possible to adjust this element as follows in the alloy:
0.001-0.05%
0.008-0.05%

The elements sulfur and boron can be present in the alloy as follows:

Sulfur no more than 0.005%
Boron no more than 0.003%

Moreover, the calcium content of the alloy can be between 0.005 and 0.07%, in particular 0.001 to 0.05% or 0.01 to 0.05%.

If the effectiveness of the reactive element lanthanum alone is not adequate for producing the material properties set forth in the statement of the object, the alloy can moreover contain at least one of the elements Ce, Y, Zr, Hf, Ti at a content of 0.01 to 0.3%, which can also be defined additives as needed.

Additions of elements with an affinity for oxygen, such as La, Ce, Y, Zr, Hf, and Ti improve service life. They do this in that they are included in the oxide layer and there block the diffusion path of the oxygen on the grain boundaries. The quantity of the element available for this mechanism must therefore be calibrated to the atomic weight in order to be able to compare the quantities of different elements to one another.

The potential of the effective elements (PwE) is therefore defined as

PwE=200·Σ(X_{F}/atomic weight of E)

where E is the element in question and X_{E} is the content of the element in question in percent.

As already addressed, the alloy can contain 0.01 to 0.3% of one or more of the elements La, Ce, Y. Zr, Hf, Ti, wherein

ΣPwE=1.43·X_{Ce}+1.49·X_{La}+2.25·X_{Y}+2.19·X_{Zr}+1.12·X_{Hf}+4.18·X_{Ti}≦0.38, in particular ≦0.36 (at 0.01 to 0.2% of the entire element), wherein PwE equals the potential of the effective elements.

Alternatively, when at least one of the elements La, Ce, Y, Zr, Hf, Ti is present in contents of 0.02 to 0.10%, it is possible for the sum PwE=

1.43·X_{Ce}+1.49·X_{La}+2.25·X_{Y}+2.19·X_{Zr}+1.12·X_{HF}+4.18·X_{Ti} to be less than or equal to 0.36, wherein PwE equals the potential of the effective elements.

The alloy can moreover have a phosphorous content between 0.01 to 0.20%, in particular 0.005 to 0.020%.

Moreover, the alloy can contain between 0.01 and 1.0% of one or more of the elements Mo, W, V, Nb, Ta, Co, which can furthermore be limited as follows:
0.01 to 0.2%
0.01 to 0.06%

Finally, the elements copper, lead, zinc, and tin can be present as impurities in contents as follows:

| | |
|---|---|
| Cu | no more than 1.0% |
| Pb | no more than 0.002% |
| Zn | no more than 0.002% |
| Sn | no more than 0.002% |

The inventive alloy is to be used in electrical heating elements, in particular electrical heating elements that require high dimensional stability and not much sagging.

One specific application for the inventive alloy is its use in constructing furnaces.

### BRIEF DESCRIPTION OF THE DRAWINGS

FIG. 1 is a graphical representation of relative burn time and potential for various alloys;

FIG. 2 is a graphical representation of relative burn time as a function of nickel content;

FIG. 3 is a graphical representation of sagging for prior art alloys as a function of nickel content;

FIG. 4 is a graphical representation of sagging for prior art alloys and test alloys as a function of carbon content;

FIG. 5 is a graphical representation of sagging for prior art alloys and test alloys as a function of nitrogen content;

FIG. 6 is a graphical representation of sagging for prior art alloys and test alloys as a function of total C+N content;

FIG. 7 is Table 1;

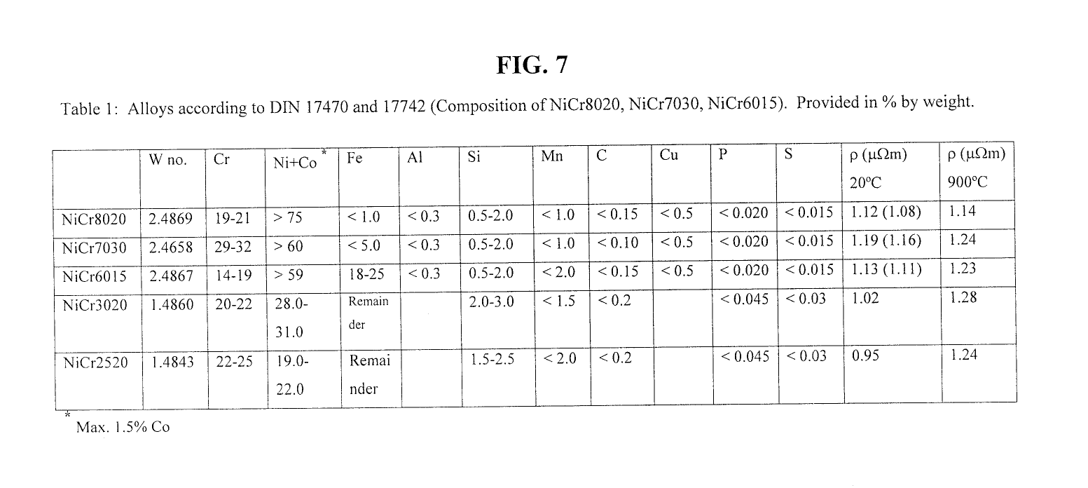

FIG. 8 is Table 2;

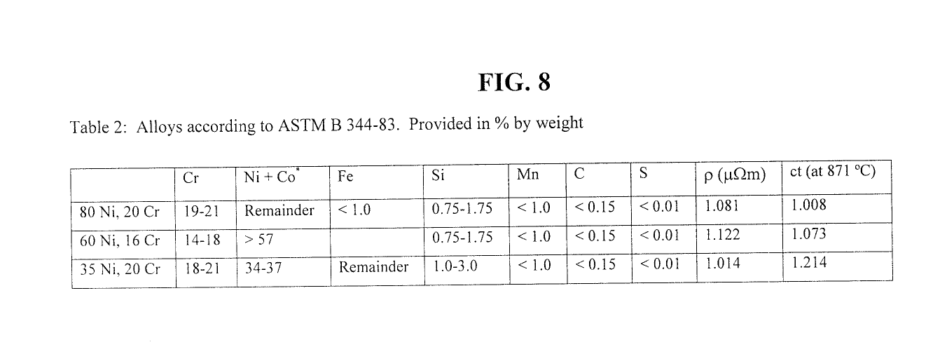

FIG. 9 is Table 3;

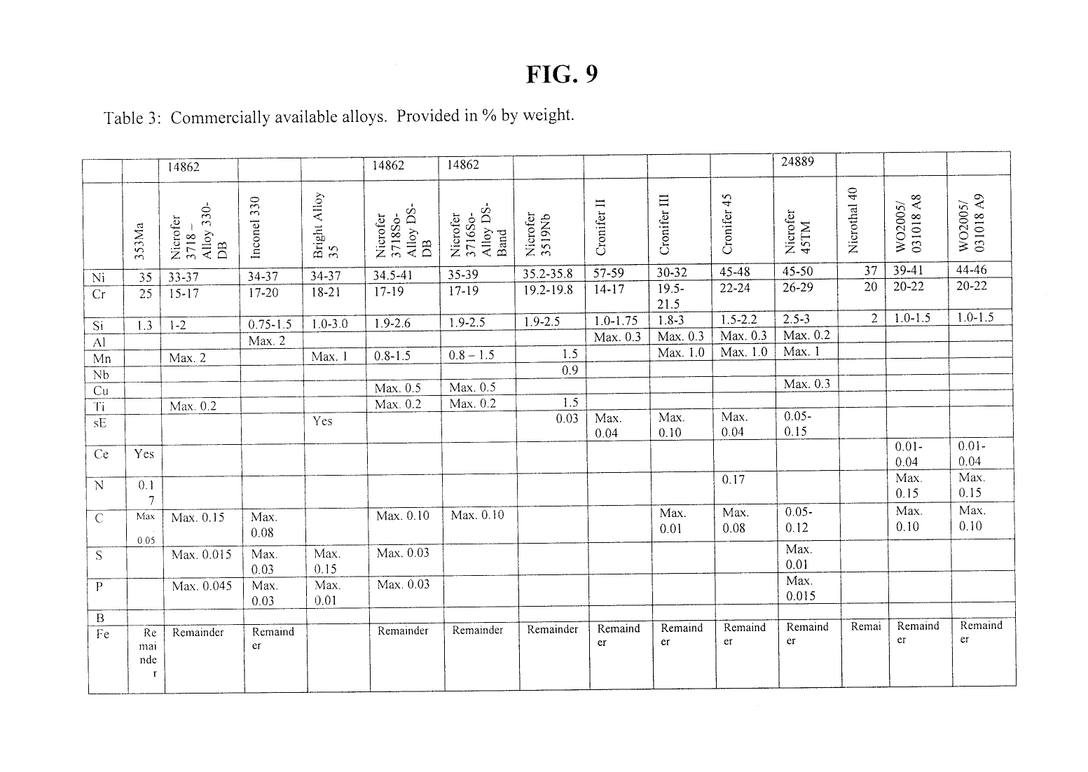

FIG. 10 is Table 4a; and

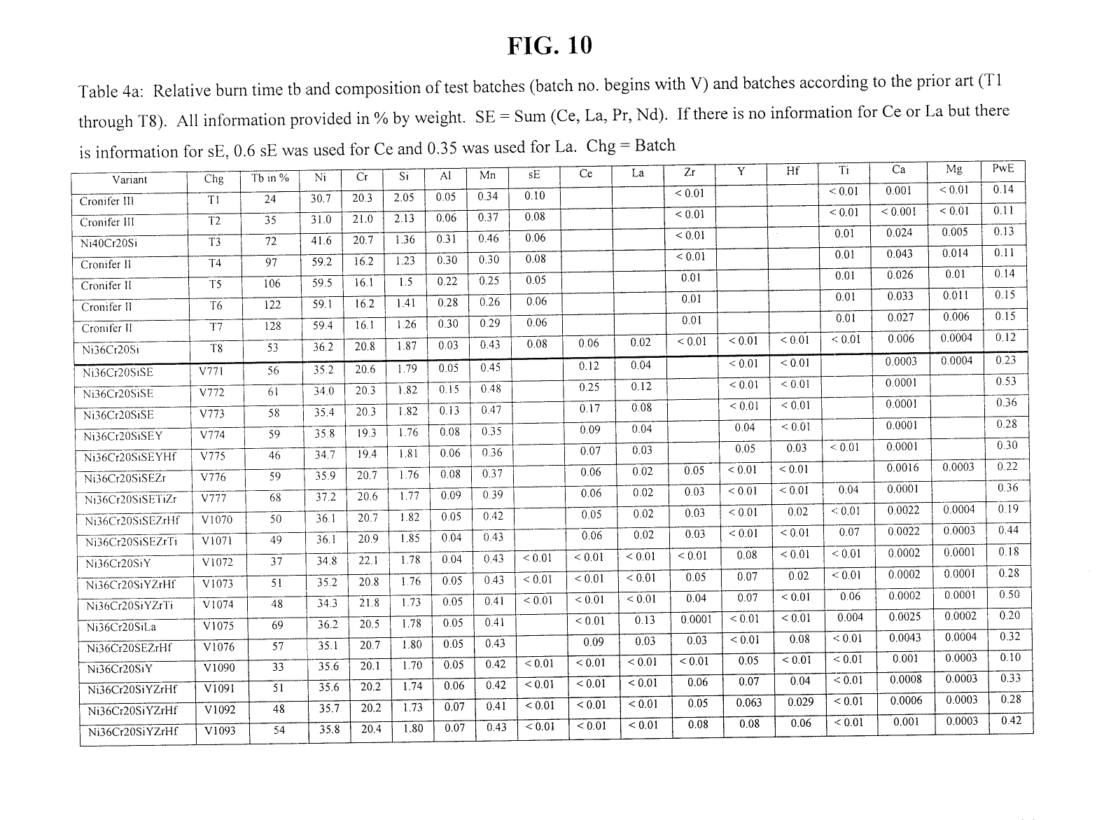

FIG. 11 is Table 4b.

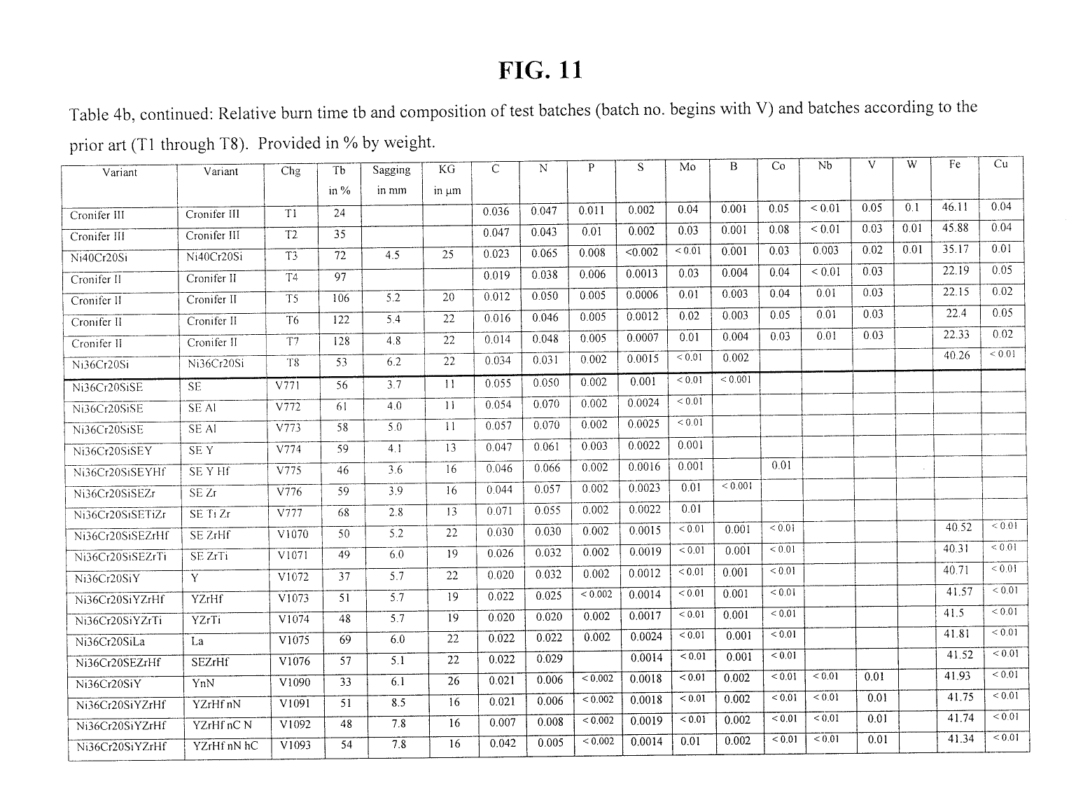

### DETAILED DESCRIPTION OF THE INVENTION

The inventive subject-matter is described in greater detail using the following examples.

### Examples

As stated in the foregoing, Tables 1 through 3 reflect the prior art.

Tables 4a and 4b depict industrial-scale melted iron-nickel-chromium-silicon alloys according to the prior art T1 through T7, an alloy melted on the laboratory scale according to the prior art T8, and a plurality of inventive test alloys V771 through V777, V1070 through V1076, V1090 through V1093, melted on the laboratory scale, for optimizing the alloy composition.

For the alloys T8 melted on the laboratory scale, V771-V777, V1070-V1076, V1090-V1093, a soft annealed wire with a diameter of 1.29 mm was produced, from the material cast in blocks, by means of hot rolling, cold drawing, and appropriate intermediate and final annealing.

For the industrially melted alloys T1-T7, a manufactured and soft annealed specimen with a 1.29 mm diameter was taken from industrial production. A smaller quantity of the wire was drawn on the laboratory scale up to 0.4 mm for the service life test.

For heat conductors in the form of wire, it is possible and usual to use accelerated service life to compare materials to one another for instance under the following conditions:

The heat conductor service life test is performed on wires having a 0.40 mm diameter. The wire is clamped between 2 current supplies spaced 150 mm apart and heated by applying a voltage up to 1150° C. Heating at 1150° C. is performed for 2 minutes, then the current supply is interrupted for 15 seconds. At the end of the service life, the wire fails because the cross-section melts. The burn time is sum of the “on” times during the service life of the wire. The relative burn time tb is the % of the burn time for a reference batch.

For examining the dimensional stability, the sagging behavior of heating coils at the application temperature is investigated in a sagging test. For heating coils, in this test coil sagging from the horizontal is determined after a certain period of time. The less sagging, the greater the dimensional stability and creep resistance of the material.

For this test, soft annealed wire with a 1.29 mm diameter is wound into spirals having a 14 mm interior diameter. In total, 6 heating coils, each having 31 windings, are produced for each batch. All of the heating coils are regulated at a uniform starting temperature of 1000° C. at the beginning of the test. A pyrometer determines the temperature. The test is performed at constant voltage in a cycle of 30 s “on”/30 s “off”. The test concludes after 4 hours. Once the heat coils have cooled off, sagging of the individual coils from the horizontal is measured and the mean of the 6 values is found. These figures (mm) are entered into Table 4b.

Table 4a and 4b list examples for the alloys in accordance with the prior art T1 through T7. T1 and T2 are alloys having approx. 30% nickel, approx. 20% Cr, and approx. 2% Si. They contain additions of rare earths (SE), in this case cerium mixed metal, which means that SE comprises 60% Ce. approx. 35% La, and the remainder Pr and Nd. The relative burn time is 24% or 335%.

Example T3 is an alloy having approx. 40% nickel, approx. 20% Cr, and approx. 1.3% Si. It contains additions of rare earths (SE), in this case cerium mixed metal, which means that SE is approx. 60% Ce, approx. 35% La, and the remainder Pr and Nd. The relative burn time is 72%.

Examples T4 through T7 are alloys having approx. 60% nickel, approx. 16% Cr, and approx. 1.2-1.5% Si. They contain additions of rare earths (SE), in this case cerium mixed metal, which means that SE is approx. 60% Ce, approx. 35% La, and the remainder Pr and Nd. The relative burn time ranges from 100 to 130%.

Moreover, Tables 4a and 4b contain a number of alloys melted on the laboratory scale. The alloy according to the prior art T8 melted on the laboratory scale is an alloy having 36.2% nickel, 20.8% Cr, and 1.87% Si.

Like the industrially produced alloys T1-T7, it contains additions of rare earths (SE) in the form of cerium mixed metal, which means that SE is approx. 60% Ce, approx. 35% La, and the remainder Pr and Nd, and, apart from the Ni, Cr, and Si content, was melted in the same way as the industrial batches. The batches according to the prior art T1 through T8 are thus directly comparable. The relative burn time for T8 is 53%.

For the inventive tested alloys that were melted on the laboratory scale, V771 through V777, V1070 through V1076, V1090 through V1093, the Ni content is approx. 36%, the Cr content is approx. 20% and the Si content is approx. 1.8%. The additions of Ce, La, Y, Zr, Hf, Ti, Al, Ca, Mg, C, and N were varied. These batches can therefore be compared directly to the alloy from the prior art T8, which thus acts as the reference alloy for optimization purposes.

Ce and La are added to V771 through V777, V1070, V1071, and V1076 by adding cerium mixed metal. In addition to Ce and La, these batches therefore contain slight quantities of Pr and Nd, but these have not been explicitly added to Table 4a because the quantities are so small.

As stated in the foregoing, elements with an affinity for oxygen improve service life. They do this in that they are included in the oxide layer and there block the diffusion paths of the oxygen on the grain boundaries. The quantity of the elements available for this mechanism must therefore be scaled to the atomic weight in order to be able to compare the quantities of different elements to one another.

The potential of the effective elements (PwE) is therefore defined as

PwE=200·Sum(X_{E}/atomic weight of E)

where E is the element in question and X_{E} is the content of the element in question in percent.

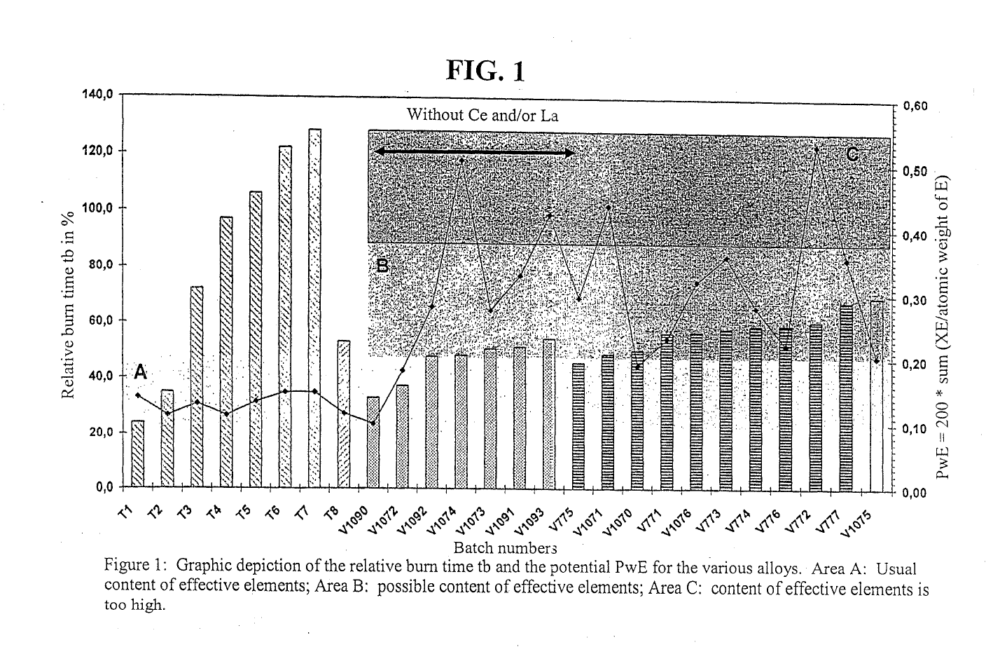

FIG. 1 is a graphic depiction of the relative burn time tb and the potential PwE for the various alloys listed in Tables 4a and 4b. Area A: Usual content of effective elements; Area B: possible content of effective elements; Area C: content of effective elements is too high.

When comparing T6 to T7, it is evident that the content of SE is the same, but T7 has a lower content of Ca and Mg, despite a slightly longer service life. It seems that Ca and Mg are no longer among the effective elements when in the presence of SE, that is, Ce or La. These two elements are not included in the potential for the effective elements because in the laboratory melts without SE, that is Ce or La, Ca or Mg is always less than or equal to 0.001%.

The addition for the potential of the effective elements PwE was therefore performed using Ce, La, Y, Zr, Hf, and Ti. If there is no figure for Ce or La, but rather only the combined figure for SE is given due to the addition of cerium mixed metal, Ce=0.6 SE and La=0.35 SE is assumed for calculating the PwE.

PwE=1.43·X_{Ce}+1.49·X_{La}+2.25·X_{Y}+2.19·X_{Zr}+1.12·X_{Hf}+4.18·X_{Ti}

For alloys according to the prior art T1 through T8, PwE is between 0.11 (T2 and T4) and 0.15 (T6 and T7). The alloy according to the prior art T8, which is also the reference alloy for the test melts, has a PwE of 0.12.

The test melts V1090 and V1072, to which no cerium mixed metal was added, i.e. no Ce or La, but rather Y, demonstrate a shorter relative burn time than T8, although, at 0.10, V1090 has a slightly lower PwE, but, at 0.18, V1072 has a greater PwE. The effect of Y does not seem to be as good as that of Ce and/or La, so that replacing Ce with Y leads to worse results compared to the prior art. With further additions of Zr and Ti (V1074) or Zr and Hf (V1092, V1073, V1091, V1093) in different quantities it was possible to attain the service life for T8. However, a PwE of greater than 0.28 was necessary for this in every case (0.28 for V1092 and V1073; 0.50 for V1074; 0.33 for V1091; and 0.42 for V1093). This increases the costs due to a higher demand for expensive elements with an affinity to oxygen and is therefore not advantageous.

Test melts V771 through V777, V1070, V1071 were all melted with cerium mixed metal, V1075 contains only La. Of these test melts, test melts V1075 and V777 attained the highest relative burn time, approx. 70%. At 0.36, the PwE of V777 is significantly greater than in V1075, at 0.20, which is on the edge of the PwE for the alloys according to the prior art. It is thus apparent that a high quantity of elements with an affinity to oxygen is not critical for attaining a high relative burn time, but rather it is much more important to add defined elements with an affinity to oxygen. V77 attained a similarly good relative burn time with a combination of 0.06% Ce, 0.02% La, 0.03% Zr, and 0.04% Ti. However, a much greater PwE of 0.36 is needed for this than with V1075. Although it contains the same quantity of La as V1075, the relative burn time for V772 is slightly less than for V1075 and V777. If the content of elements with an affinity to oxygen is too high, this leads to increased inner oxidation and thus the ultimate effect is a reduction in the relative burn time. Thus it does not appear useful for the PwE to significantly exceed 0.36. At 0.23, the PwE for V771 is only slightly greater than that for V1075, but the relative burn time is significantly less. In V771, a majority of the elements with an affinity to oxygen comprises Ce and only the smaller portion comprises La. Consequently it seems that La is much more effective as an addition that improves burn time than Ce. Evidently this also cannot be compensated by a significant increase in both Ce, to 0.17% and La, to 0.08%, as V773, with a nearly equivalent relative burn time of 58%, demonstrates with an increased PwE of 0.36. This confirms the assertion, made in the foregoing, that a PwE that is significantly greater than 0.36 does not make sense. But even with a PwE of 0.22, as for V776, with a relative burn time of 59%, a combination of Ce=0.06% and La=0.02% and Zr=0.05% does not seem as effective as the addition of just La in V1075, which means that even Zr is not as effective as La. The same applies for further addition of Y to Ce and La, as V774 (PwE=0.28) demonstrates and a combination of Ce, La, Zr, and H-if, as V1070 (PwE=0.19) demonstrates. A 1.7-fold increase in the PwE to 0.32 for the combination Ce, La, Zr, and Hf only extends the relative burn time by 1.15-fold for V1076, which again demonstrates that PwEs that are too high are not as effective. This is again evident when comparing V1071 to V777. V1071 has the same content of Ce, La, and Zr as V777, but its Ti content is significantly higher, which means a PwE of 0.44 and, in comparison to V777, a significantly lower burn time of only 49%. At 0.07% Ce and 0.03% La, 0.005% Y, and 0.03% Hf, with a PwE of 0.30, V775 has a relative burn time of only 46%, which indicates that adding Y and Zr to Ce and La is not very effective.

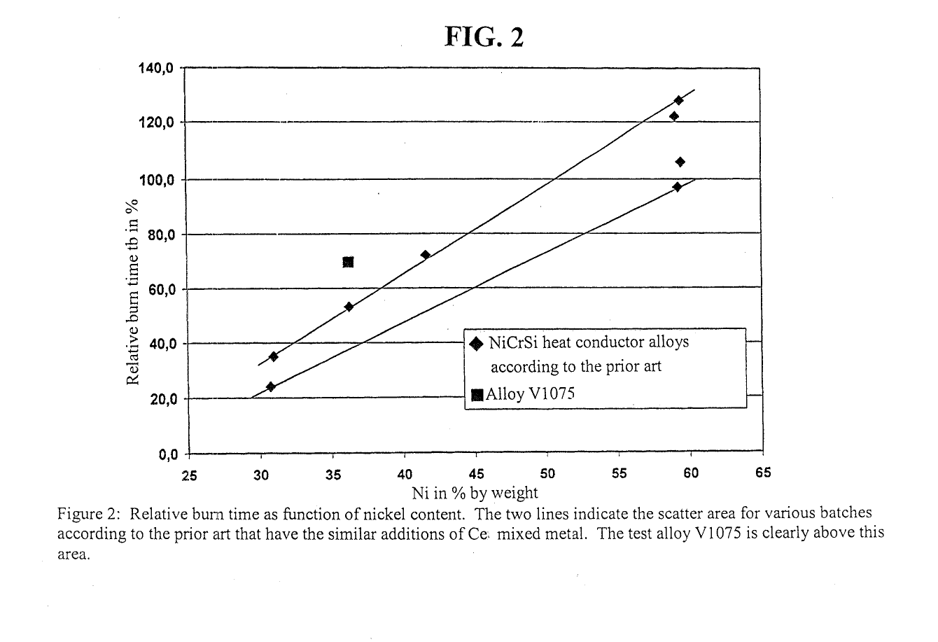

FIG. 2 is a graphic depiction of the relative burn time and PwE to help clarify the information in the foregoing. FIG. 2 depicts the relative burn times for the alloys T1 through T8 according to the prior art as a function of the nickel content. The straight lines limit the relative burn time scatter band into which the alloys according to the prior art fall as a function of nickel content. Also plotted is the test alloy V1075 with the addition of the most effective element, La. Its service life is clearly above the scatter band.

Table 4b summarizes sagging and the grain size of the wires. The alloys according to the prior art T1 through T8 exhibit sagging between 4.5 and 6.2 mm with comparable grain sizes between 20 and 25 μm.

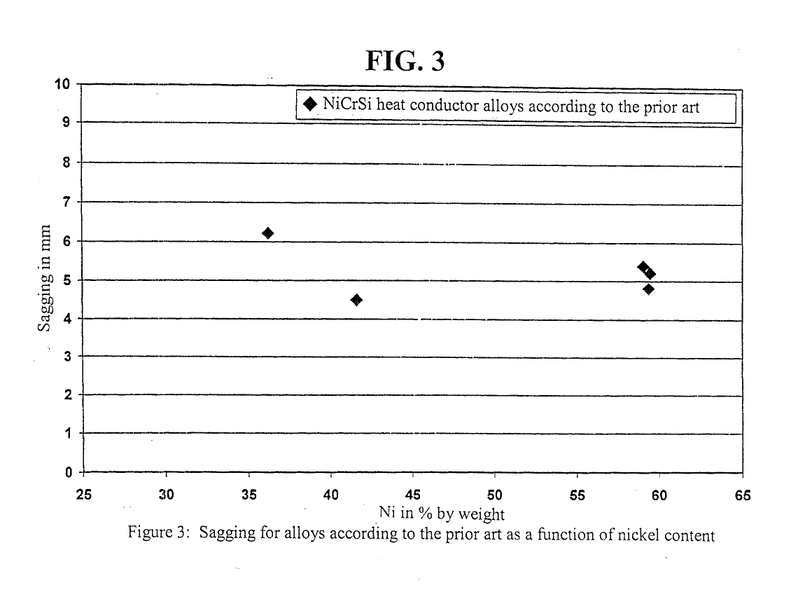

FIG. 3 plots nickel content. However, nickel content does not appear critical for sagging.

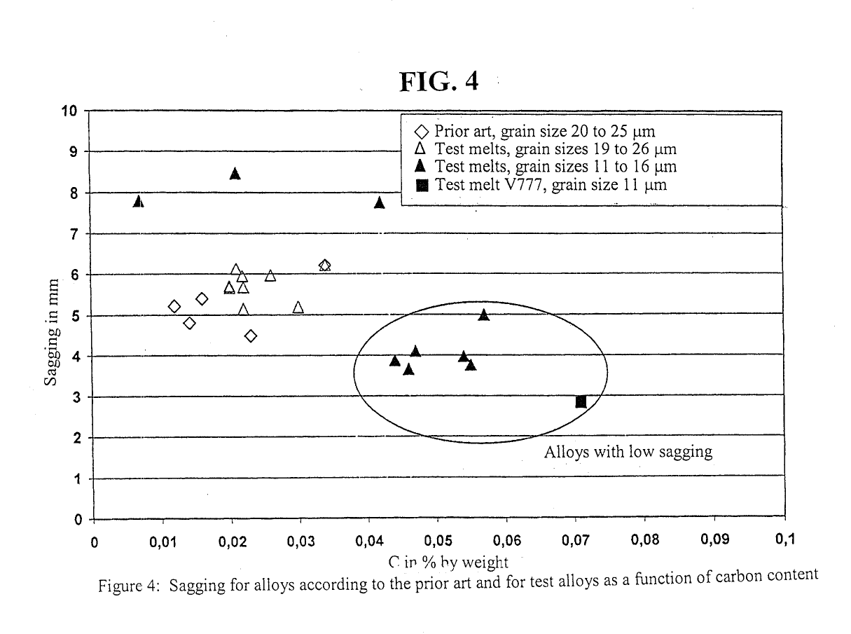

FIG. 4 plots C content for alloys T1 through T8 and the test alloys. Since the test alloys have different grain sizes, they were divided into 2 categories: grain sizes of 19 to 26 μm and grain sizes of 11 to 16 μm. The alloys T1 through T8 and the test alloys having a grain size of 19 μm to 26 μm that have comparable grain sizes all exhibit similar sagging, ranging from 4.5 to 6.2 mm. The test alloys that have a grain size of 11 to 16 μm and a carbon content less than 0.042% exhibit greater sagging, approx. 8 mm, as is to be expected due to the smaller grain size. The test alloys having a grain size of 11 to 16 μm and a carbon content greater than 0.044% unexpectedly exhibit less sagging, 2.8 to 5 mm.

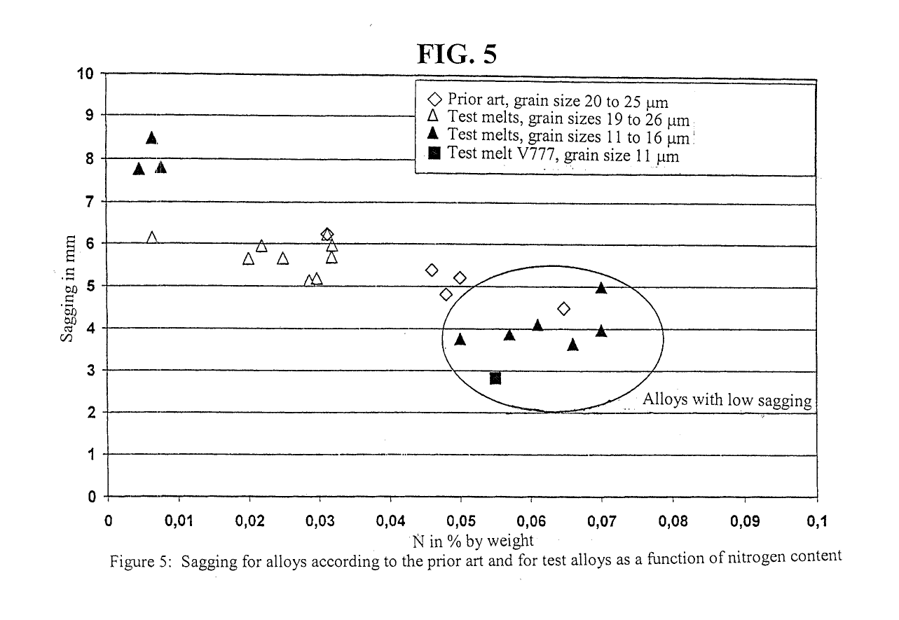

FIG. 5 plots N content for the alloys T1 through T8 and the test melts. The alloys T1 through T8 and the test alloys having a grain size of 19 μm to 26 μm that all have comparable grain sizes exhibit reduced sagging as the N content rises. As is to be expected, the test alloys that have a grain size of 11 to 16 μm and an N content less than 0.010% exhibit greater sagging than all of the alloys having a grain size of 19 to 26 μm. The test alloys having a grain size of 11 to 16 μm and a carbon content greater than 0.044%, and that also have a nitrogen content greater than 0.045%, unexpectedly exhibit equal or less sagging than all of the alloys having a grain size of 19 to 26 μm.

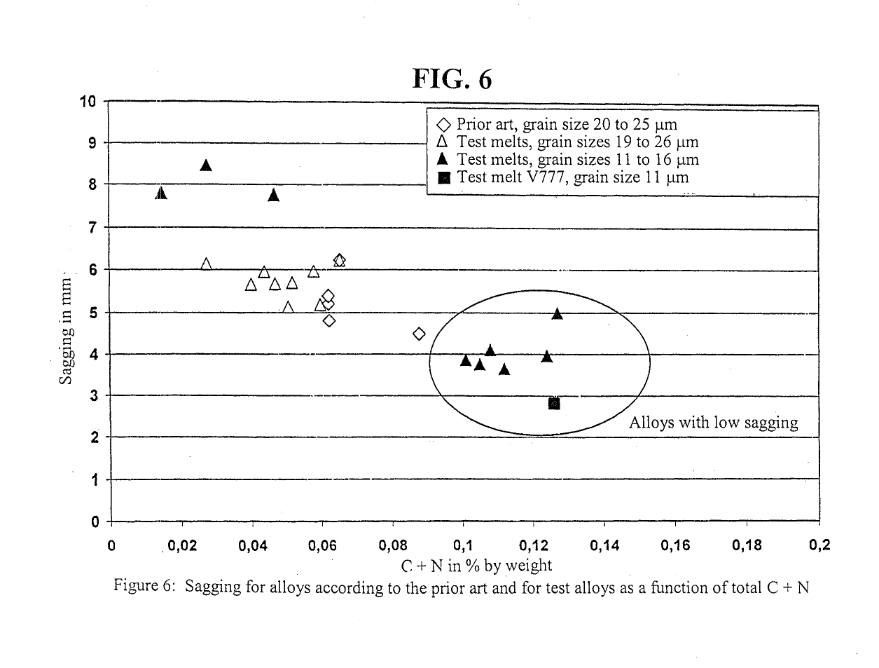

FIG. 6 plots the total C+N. It again illustrates how C+N together significantly reduce sagging. The alloys T1 through T8 and the test alloys having a grain size from 19 μm to 26 μm, which all have comparable grain sizes, exhibit less sagging as C+N content increases. As is to be expected, due to the grain size the test alloys that have a grain size of 11 to 16 μm and a C+N content less than 0.060% exhibit greater sagging than all of the alloys having a grain size of 19 to 26 μm. The test alloys having a grain size from 11 to 16 μm and a C+N content greater than 0.09%, comprising a carbon content greater than 0.044% and at the same time a nitrogen content greater than 0.045%, unexpectedly exhibit sagging equal to or less than all alloys having a grain size of 19 to 26 μm.

A higher C or N content thus causes such a sharp reduction in sagging that the effect of a smaller grain size, which increases sagging, is not completely compensated. The test alloys were all subjected to a standard heat treatment.

As Table 4b illustrates, smaller grain sizes occur especially with a C content greater than 0.04%. When the standard heat treatment is changed to slightly higher temperatures at which the larger grain sizes then occur, a further reduction in sagging can be attained in these alloys having a C content greater than 0.04%.

The alloy V777 exhibits the least sagging of all of the alloys. It has the highest C content and the N content is in the top third. High C content consequently seems particularly effective in reducing sagging.

Nickel contents below 34% have too negative an impact on service life (relative burn times), the specific electrical resistance, and the ct value. Therefore 34% is the lower limit for nickel content. Nickel content that is too high increases costs due to the high cost of nickel. Therefore 42% should be the upper limit for nickel content.

Cr content that is too low means that the Cr concentration drops below the critical limit too fast. Therefore 18% Cr is the lower limit for chromium. Cr content that is too high has a negative impact on the processability of the alloy. Therefore 26% Cr is the upper limit.

Formation of a silicon oxide layer beneath the chromium oxide layer reduces the oxidation rate. Below 1% the silicon oxide layer has too many gaps to attain its full potential. Si content that is too high has a negative effect on the processability of the alloy. Therefore an Si content of 2.5% is the upper limit.

A minimum content of 0.01% La is necessary to retain the effect of the La, which increases oxidation resistance. The upper limit is 0.26%, which corresponds to a PwE of 0.38. Greater PwE values do not make sense, as explained in the examples.

Al is required for improving the processability of the alloy. Therefore a minimum content of 0.05% is necessary. If the content is too high, this has a negative effect on processability. The Al content is therefore limited to 1%.

A minimum content of 0.01% C is necessary for good dimensional stability and low sagging. C is limited to 0.14% because this element reduces oxidation resistance and processability.

A minimum content of 0.01% N is necessary for good dimensional stability and low sagging. N is limited to 0.14% because this element reduces oxidation resistance and processability.

For Mg, a minimum content of 0.001% is necessary because this improves the processability of the material. The limit is set at 0.05% in order not to soften the positive effect of this element.

The sulfur and boron content should be kept as low as possible because these surfactant elements have a negative effect on oxidation resistance. Therefore limits are set at no more than 0.01% S and no more than 0.005% B.

Copper is limited to no more than 1% because this element reduces oxidation resistance.

Pb is limited to no more than 0.002% because this element reduces oxygen resistance. The same applies to Sn.

A minimum content of 0.01% Mn is necessary for improving processability. Manganese is limited to 1% because this element reduces oxidation resistance.

1.-42. (canceled)

43. An electrical heating element in the form of a wire comprising an iron-nickel-chromium-silicon alloy, the alloy comprising, in % by weight, 34 to 38% nickel, 20 to 24% chromium, >1.0 to 2.5% silicon, and further comprising, as additives: 0.05 to 1% Al, 0.01 to 1% Mn, 0.01 to 0.26% lanthanum, 0.0005 to 0.05% magnesium, 0.01 to 0.14% carbon, >0.02 to 0.14% nitrogen, no more than 0.01% sulfur, no more than 0.005% B, and optionally comprising at least one of the elements Ce, Y, Zr, Hf, Ti, each in an amount of 0.01 to 0.3%, wherein the solution to the equation PwE=1.43·X_{Ce}+1.49·X_{La}+2.25·X_{Y}+2.19·X_{Zr}+1.12·X_{Hf}+4.18 X_{Ti} is greater than 0.11 and less than or equal to 0.38, wherein PwE is the potential of effective elements listed in the equation and X is the number corresponding to the percentage content of the element identified in the respective subscript, the remainder being iron and the usual impurities resulting from the production process, and wherein Mo and W are not present in the alloy.

44. The electrical heating element in the form of a wire of claim 43, wherein the nickel content of the alloy is 34 to 37% by weight.

45. The electrical heating element in the form of a wire of claim 43, wherein the nickel content of the alloy is 37 to 38% by weight.

46. The electrical heating element in the form of a wire of claim 43, wherein the chromium content of the alloy is 21 to 24% by weight.

47. The electrical heating element in the form of a wire of claim 43, wherein the silicon content of the alloy is 1.5 to 2.5% by weight.

48. The electrical heating element in the form of a wire of claim 43, wherein the silicon content of the alloy is >1.0 to 1.5% by weight.

49. The electrical heating element in the form of a wire of claim 43, wherein the silicon content of the alloy is 1.5 to 2.0% by weight.

50. The electrical heating element in the form of a wire of claim 43, wherein the silicon content of the alloy is 1.7 to 2.5% by weight.

51. The electrical heating element in the form of a wire of claim 43, wherein the silicon content of the alloy is 1.2 to 1.7% by weight.

52. The electrical heating element in the form of a wire of claim 43, wherein the silicon content of the alloy is 1.7 to 2.2% by weight.

53. The electrical heating element in the form of a wire of claim 43, wherein the silicon content of the alloy is 2.0 to 2.5% by weight.

54. The electrical heating element in the form of a wire of claim 43, wherein the aluminum content of the alloy is 0.1 to 0.7% by weight.

55. The electrical heating element in the form of a wire of claim 43, wherein the manganese content of the alloy is 0.1 to 0.7% by weight.

56. The electrical heating element in the form of a wire of claim 43, wherein the lanthanum content of the alloy is 0.04 to 0.20% by weight.

57. The electrical heating element in the form of a wire of claim 43, wherein the lanthanum content of the alloy is 0.04 to 0.15% by weight.

58. The electrical heating element in the form of a wire of claim 43, wherein the nitrogen content of the alloy is >0.02 to 0.10% by weight.

59. The electrical heating element in the form of a wire of claim 43, wherein the nitrogen content of the alloy is 0.03 to 0.09% by weight.

60. The electrical heating element in the form of a wire of claim 43, wherein the carbon content of the alloy is 0.04 to 0.14% by weight.

61. The electrical heating element in the form of a wire of claim 43, wherein the carbon content of the alloy is 0.04 to 0.10% by weight.

62. The electrical heating element in the form of a wire of claim 43, wherein the magnesium content of the alloy is 0.001 to 0.05% by weight.

63. The electrical heating element in the form of a wire of claim 43, wherein the magnesium content of the alloy is 0.008 to 0.05% by weight.

64. The electrical heating element in the form of a wire of claim 43, wherein the sulfur content of the alloy is no more than 0.005% by weight and the B content of the alloy is no more than 0.003% by weight.

65. The electrical heating element in the form of a wire of claim 43, wherein the alloy further comprises, by weight, 0.0005 to 0.07% Ca.

66. The electrical heating element in the form of a wire of claim 65, wherein the Ca content of the alloy is 0.001 to 0.05% by weight.

67. The electrical heating element in the form of a wire of claim 65, wherein the Ca content of the alloy is 0.01 to 0.05% by weight.

68. The electrical heating element in the form of a wire of claim 43, wherein the alloy contains, in total, two or more of the elements selected from La, Ce, Y, Zr, Hf, and Ti in an amount, by weight, of 0.05 to 0.2% and PwE is greater than 0.11 and less than or equal to 0.36.

69. The electrical heating element in the form of a wire of claim 68, wherein the alloy contains, in total, two or more of the elements La, Ce, Y, Zr, Hf, and Ti in an amount, by weight, of 0.05 to 0.15%.

70. The electrical heating element in the form of a wire of claim 43, wherein the alloy further comprises, by weight, 0.001 to 0.020% phosphorus.

71. The electrical heating element in the form of a wire of claim 70, wherein the phosphorus content of the alloy is 0.005 to 0.020% by weight.

72. The electrical heating element in the form of a wire of claim 43, wherein the alloy further comprises one or more of the elements V, Nb, Ta, Co in a total amount of 0.01 to 1.0% by weight.

73. The electrical heating element in the form of a wire of claim 72, wherein the total amount of one or more of the elements V, Nb, Ta, Co is 0.01 to 0.2% by weight.

74. The electrical heating element in the form of a wire of claim 72, wherein the total amount of one or more of the elements V, Nb, Ta, Co is 0.01 to 0.06% by weight.

75. The electrical heating element in the form of a wire of claim 43, wherein the impurities in the alloy comprise, by weight, not more than 1.0% Cu, not more than 0.002% Pb, not more than 0.002% Zn, and not more than 0.002% Sn.

76. A furnace comprising the electrical heating element in the form of a wire of claim 43.

77. An electrical heating element in the form of a wire comprising an iron-nickel-chromium-silicon alloy, the alloy comprising, in % by weight:
34 to 38% nickel, 20 to 24% chromium, >1.0 to 2.5% silicon, and, as additives, in percent by weight,
0.05 to 1% Al,
0.01 to 1% Mn,
0.04 to 0.26% lanthanum,
0.0005 to 0.05% magnesium,
0.01 to 0.14% carbon,
>0.02 to 0.14% nitrogen,
the alloy also having common impurities from the production process, and wherein the electrical heating element in the form of a wire comprising the alloy exhibits a relative burn time of 55% or greater, good dimensional stability, and low sagging, wherein Mo and W are not present in the alloy.

78. The electrical heating element in the form of a wire of claim 43, wherein the wire is further in the form of a heating coil.

79. The electrical heating element in the form of a wire of claim 77, wherein the wire is further in the form of a heating coil.

80. The electrical heating element in the form of a wire of claim 43, the alloy further comprising 0.01 to 0.3% by weight, in total, of at least one of the elements Ce, Y, Zr, Hf, Ti, wherein the solution to the equation PwE=1.43·X_{Ce}+1.49·X_{La}+2.25·X_{Y}+2.19·X_{Zr}+1.12·X_{Hf}+4.18 X_{Ti} is greater than 0.11 and less than or equal to 0.38, wherein PwE is the potential of effective elements listed in the equation and X is the number corresponding to the percentage content of the element identified in the respective subscript.

81. The electrical heating element in the form of a wire of claim 80 wherein PwE has an upper limit that is less than 0.36.

82. The electrical heating element in the form of a wire of claim 77, the alloy further comprising 0.01 to 0.3% by weight, in total, of at least one of the elements Ce, Y, Zr, Hf, Ti, wherein the solution to the equation PwE=1.43·X_{Ce}+1.49·X_{La}+2.25·X_{Y}+2.19·X_{Zr}+1.12·X_{Hf}+4.18 X_{Ti} is greater than 0.11 and less than or equal to 0.36, wherein PwE is the potential of effective elements listed in the equation and X is the number corresponding to the percentage content of the element identified in the respective subscript.

83. The electrical heating element in the form of a wire of claim 77, wherein the lanthanum content of the alloy is 0.04 to 0.15% by weight.
